(19) United States
(12) Patent Application Publication
(10) Pub. No.: US 2026/0238762 A1
(43) Pub. Date: Aug. 13, 2026

(54) Methods and Apparatus for Intra Multiple Reference Line Prediction in an Image and Video Coding System

(71) Applicant: MEDIATEK INC., Hsinchu City (TW)

(72) Inventor: Shih-Ta HSIANG, Hsinchu City (TW)

(21) Appl. No.: 19/475,107

(22) PCT Filed: Apr. 22, 2024
(86) PCT No.: PCT/CN2024/089129

§ 371 Date: Oct. 14, 2025

Related U.S. Application Data
(60) Provisional application No. 63/500,644, filed on May 8, 2023.

(51) Int. Cl. H04N 19/105; H04N 19/159; H04N 19/174; H04N 19/176

(52) U.S. Cl. CPC H04N 19/105; H04N 19/159; H04N 19/174; H04N 19/176

(57) ABSTRACT

A method and apparatus for video coding using a multi-line fused predictor are disclosed. According to this method, a reference region is determined, wherein the reference region comprises multiple reference lines. Two or more target intra predictors for a target intra prediction mode are determined, wherein each of said two or more target intra predictors is derived using one or more respective reference lines in the reference region. A fused intra predictor is derived by combining said two or more target intra predictors using adaptive weights, wherein the adaptive weights are determined by using information comprising input video contents, coding conditions, coded neighbouring samples of the current block, or a combination thereof. The current block is encoded or decoded by using intra prediction candidate comprising the fused intra predictor.

### CROSS REFERENCE TO RELATED APPLICATIONS

The present invention is a non-Provisional Application of and claims priority to U.S. Provisional Patent Application No. 63/500,644, filed on May 8, 2023. The U.S. Provisional Patent Application is hereby incorporated by reference in its entirety.

### FIELD OF THE INVENTION

The present invention relates to video coding system. In particular, the present invention relates to generating a fused intra predictor using adaptive weighting.

### BACKGROUND

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology-Coded representation of immersive media—Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video encoding system incorporating loop processing. For Intra Prediction 110, the prediction data is derived based on previously coded video data in the current picture. For Inter Prediction 112, Motion Estimation (ME) is performed at the encoder side and Motion Compensation (MC) is performed based on the result of ME to provide prediction data derived from other picture(s) and motion data. Switch 114 selects Intra Prediction 110 or Inter Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, is provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

In VVC, the Sequence Parameter Set (SPS) and the Picture Parameter Set (PPS) contain high-level syntax elements that apply to entire coded video sequences and pictures, respectively. The Picture Header (PH) and Slice Header (SH) contain high-level syntax elements that apply to a current coded picture and a current coded slice, respectively.

In VVC, a coded picture is partitioned into non-overlapped square block regions represented by the associated coding tree units (CTUs). A coded picture can be represented by a collection of slices, each comprising an integer number of CTUs. The individual CTUs in a slice are processed in raster-scan order. A bi-predictive (B) slice may be decoded using intra prediction or inter prediction with at most two motion vectors and reference indices to predict the sample values of each block. A predictive (P) slice is decoded using intra prediction or inter prediction with at most one motion vector and reference index to predict the sample values of each block. An intra (I) slice is decoded using intra prediction only.

In VVC, each CTU can be partitioned into one or multiple non-overlapped coding units (CUs) using a Quaternary Tree (QT) with nested Multi-Type-Tree (MTT) structure. The partitioning information is signalled by a coding tree syntax structure, where each CTU is treated as the root of a coding tree. The CTUs may be first partitioned by the quaternary tree (a.k.a. quadtree) structure, as shown in FIG. 2A. Then the quaternary tree leaf nodes can be further partitioned by a MTT structure, as shown in FIGS. 2B-E. There are four splitting types in multi-type tree structure: vertical binary splitting (SPLIT_BT_VER), horizontal binary splitting (SPLIT_BT_HOR), vertical ternary splitting (SPLIT_TT_VER), and horizontal ternary splitting (SPLIT_TT_HOR). Each quadtree child node may be further split into smaller coding tree nodes using any one of five split types in FIG. 2. However, each multi-type-tree child node is only allowed to be further split by one of four MTT split types. The coding tree leaf nodes correspond to the coding units (CUs). FIG. 3 provides an example of a CTU recursively partitioned by QT with the nested MTT, where the bold block edges represent quadtree partitioning and the remaining edges represent multi-type tree partitioning.

Each CU contains one or more Prediction Units (PUs). The prediction unit, together with the associated CU syntax, works as a basic unit for signalling the predictor information. The specified prediction process is employed to predict the values of the associated pixel samples inside the PU. Each CU may contain one or more transform units (TUs) for representing the prediction residual blocks. A transform unit (TU) is comprised of one transform block (TB) of luma samples and two corresponding transform blocks of chroma samples. Each TB corresponds to one residual block of samples from one colour component. An integer transform is applied to a transform block. The level values of quantized coefficients together with other side information are entropy coded in the bitstream. The terms coding tree block (CTB), coding block (CB), prediction block (PB), and transform block (TB) are defined to specify the 2-D sample array of one colour component associated with CTU, CU, PU, and TU, respectively. Thus, a CTU consists of one luma CTB, two chroma CTBs, and associated syntax elements. A similar relationship is valid for CU, PU, and TU.

Joint Video Expert Team (JVET) of ITU-T SG16 WP3 and ISO/IEC JTC1/SC29/WG11 are currently in the process of exploring the next-generation video coding standard. Some promising new coding tools have been adopted into Enhanced Compression Model 8 (ECM 8) (M. Coban, F. Le Léannec, R.-L. Liao, K. Naser, J. Ström, L. Zhang “Algorithm description of Enhanced Compression Model 8 (ECM 8),” Joint Video Expert Team (JVET) of ITU-T SG 16 WP 3 and ISO/IEC JTC 1/SC 29, Doc. JVET-AC2025, 29th Meeting, by teleconference, 11-20 Jan. 2023.) to further improve VVC.

In ECM-8.0, multi-line fusion is adopted by an angular intra prediction mode to intra predict a current block, wherein a fused signal for predicting the current block is formed by a weighted sum of the two intra prediction signals derived by the reconstructed samples from the two adjacent reference lines using a specified intra prediction mode. The fused signal P_{fusion} for intra predicting the current block is given by:

$${P}_{fusion} = 0.75 * {P}_{m , n} + 0.25 * {P}_{m , n + 1} \qquad ( 1 )$$

where m is a specified intra prediction mode for the current block, n is a specified reference line index for the current block, P_{m, n} and P_{m, n+1} are the prediction signals derived by the reconstructed samples from the reference lines indexed by n and n+1, respectively, using the intra prediction mode m.

In the present invention, schemes for generating a fused intra predictor by blending two or more intra predictors using adaptive weights derived according to input video contents or coding conditions are disclosed.

### BRIEF SUMMARY OF THE INVENTION

A method and apparatus for generating a fused intra predictor by blending two or more intra predictors using adaptive weights are disclosed. According to this method, input data associated with a current block are received, wherein the input data comprises pixel data to be encoded at an encoder side or coded data associated with the current block to be decoded at a decoder side, and wherein the current block is coded in intra prediction. A reference region is determined, wherein the reference region comprises multiple reference lines. Two or more target intra predictors for a target intra prediction mode are determined, wherein said two or more target intra predictors are derived using two or more respective reference lines in the reference region. A fused intra predictor is derived by combining said two or more target intra predictors using adaptive weights, wherein the adaptive weights are determined by using information comprising input video contents, coding conditions, coded neighbouring samples of the current block, or a combination thereof. The current block is encoded or decoded by using intra prediction candidate comprising the fused intra predictor.

In one embodiment, the adaptive weights are derived based on template-matching costs calculated on one or more templates based on reconstructed samples and predicted samples of said one or more templates, wherein the predicted samples are derived according to said two or more target intra predictors. In one embodiment, said two or more target intra predictors correspond to a first target intra predictor and a second target intra predictor associated with a first reference line and a second reference line respectively and the template-matching costs correspond to a first template-matching cost and a second template-matching cost, the adaptive weights associated with the first target intra predictor and the second target intra predictor are proportional to the second template-matching cost and the first template-matching cost respectively.

In one embodiment, the adaptive weights are determined from pre-defined weight sets. In one embodiment, the pre-defined weight sets comprise (1, 0), (0.875, 0.125), (0.75, 0.25), (0.625, 0.375), (0.5, 0.5), or a combination thereof. In one embodiment, the adaptive weights are derived from pre-defined weight sets implicitly based on block dimension, quantization parameter (QP), selected reference line index n, prediction mode associated with the current block, or a combination thereof.

In one embodiment, the adaptive weights are selected according to a selected reference line index associated with a selected target intra predictor. In one embodiment, if the selected reference line index is greater than a positive threshold, a corresponding adaptive weight is set to 0.5; otherwise if the selected reference line index is greater than 0, the corresponding adaptive weight is set to 0.75; and otherwise, the corresponding adaptive weight is set to 1. In another embodiment, a smaller adaptive weight is used for a smaller selected reference line index.

In one embodiment, said two or more target intra predictors correspond to three target intra predictors and the adaptive weights comprise (0.25, 0.5, 0.25).

In one embodiment, one or more syntax elements are used to indicate values of the adaptive weights. In one embodiment, said one or more syntax elements are signalled in SPS (Sequence Parameter Set), PPS (Picture Parameter Set), PH (Picture Header), SH (Slice Header), or a combination thereof.

In one embodiment, one or more high-level syntax sets are used to indicate whether the adaptive weights are used to form the fused intra predictor. In one embodiment, said one or more high-level syntax sets are signalled in SPS (Sequence Parameter Set), PPS (Picture Parameter Set), PH (Picture Header), SH (Slice Header), or a combination thereof.

According to another method, input data associated with a current block are received, wherein the input data comprises pixel data to be encoded at an encoder side or coded data associated with the current block to be decoded at a decoder side, and wherein the current block is coded in intra prediction. A reference region is determined, wherein the reference region comprises at least three reference lines. At least three target intra predictors are determined for a target intra prediction mode, wherein each of said at least three target intra predictors is derived using one individual reference line not shared by any other target intra predictor. A fused intra predictor is derived by combining said at least three target intra predictors using a set of weights. The current block is encoded or decoded by using intra prediction candidate comprising the fused intra predictor.

In one embodiment, said at least three target intra predictors correspond to a first target intra predictor, a second target intra predictor and a third target intra predictor derived based on reference line indexes (n−1), n, and (n+1) respectively, and wherein n is an integer greater than 0. In one embodiment, the set of weights corresponds to (0.25, 0.5. 0.25).

### BRIEF DESCRIPTION OF THE DRAWINGS

FIG. 1A illustrates an exemplary adaptive Inter/Intra video coding system incorporating loop processing.

FIG. 1B illustrates a corresponding decoder for the encoder in FIG. 1A.

FIG. 2A-FIG. 2E illustrates examples of a multi-type tree structure corresponding to quadtree splitting (FIG. 2A) vertical binary splitting (SPLIT_BT_VER, FIG. 2B), horizontal binary splitting (SPLIT_BT_HOR, FIG. 2C), vertical ternary splitting (SPLIT_TT_VER, FIG. 2D), and horizontal ternary splitting (SPLIT_TT_HOR, FIG. 2E).

FIG. 3 shows an example of a CTU divided into multiple CUs with a quadtree and nested multi-type tree coding block structure, where the bold block edges represent quadtree partitioning and the remaining edges represent multi-type tree partitioning.

FIG. 4 illustrates a flowchart of an exemplary video coding system that incorporates a fused predictor with adaptive weights according to an embodiment of the present invention.

FIG. 5 illustrates a flowchart of another exemplary video coding system that incorporates a fused predictor by combining at least three intra predictors derived using individual reference lines according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

In order to improve the coding performance of fused intra prediction, various schemes related to adaptive weights are disclosed.

In the present invention, new methods are disclosed for improving intra prediction by a fusion of multiple intra predictors respectively derived by the reconstructed samples from different reference lines. In ECM-8.0, a fixed set of fusion weights (0.75, 0.25) is adopted to derive the fused signal for an angular intra prediction mode. According to one aspect of the present invention, a video coder may form a fused intra prediction signal by using adaptive fusion weights for further improving intra prediction performance. In this way, the fusion weights can be flexibly adjusted considering video contents and coding conditions. In the proposed method, a video coder may further comprise deriving a set of the weights (w0, w1) for generating a fused prediction signal by a fusion of two intra prediction signals derived from the reference lines n and n+1, respectively, for intra predicting a current block in prediction mode m, as follows:

$${P}_{fusion} = w 0 * {P}_{m , n} + w 1 * {P}_{m , n + 1} . \qquad ( 2 )$$

In some embodiments, a video coder may derive the multi-line fusion weights of a fused signal for intra predicting a current block from the coded neighboring samples. For example, a video coder may derive the fusion weights of a fused signal for intra predicting a current block by a linear regression method for optimization of the values of fusion weights according to some specified criterion exploiting the neighboring reconstructed samples of the current block. In some embodiments, a video coder may derive the fusion weights of a fused signal by a linear regression method based on the template-matching cost between a predicted signal and a reconstructed signal. For another example, a video coder may calculate a template-matching cost between a predicted signal and a reconstructed signal over a template region of a current block for each of the intra predictors derived from the reference line n and n+1, respectively, using the specified intra prediction mode. The video coder may derive the fusion weights of a fused signal for intra predicting the current block based on the template-matching costs calculated for the predictors derived by the reconstructed samples from the specified reference lines n and n+1. In one preferred embodiment, the fusion weights are set as follows:

$$w 0 = costN 1 / ( costN + costN 1 ) , and$$

$$w 1 = costN / ( costN + costN 1 ) .$$

where costN and costN1 are the template matching costs calculated for the intra predictors derived by the reconstructed samples from the reference lines n and n+1, respectively, using the specified intra prediction mode. In other words, the weights w0 and w 1 are proportional to costN1 and costN respectively.

In some embodiments, a video coder may include some pre-defined candidate sets of multi-line fusion weights for deriving a fused signal for intra predicting a current block. The video coder may derive the selected set of the fusion weights from the pre-defined candidate sets for intra predicting a current block according to some pre-defined rule. For example, a video coder may implicitly derive the set of the fusion weights for intra predicting a current block dependent on block dimension (width, height, and/or area size), quantization parameter (QP), selected reference line index n, and/or prediction mode associated with the current block. In some preferred embodiments, a video coder may derive the set of the fusion weights for intra predicting a current block dependent on whether the current block width, height, area size, and/or selected reference line index n is greater or less than one or more specified threshold values. In some preferred embodiments, a video coder may set the selected fusion weights (w0, w1) equal to (0.5, 0.5) for deriving a fused signal for intra predicting a current block when the selected reference line index for the current block is greater than a specified threshold value. The video coder may further set the selected fusion weights (w0, w1) equal to (1, 0) when the selected reference line index for the current block is less than another specified threshold value. Otherwise, the video coder may set the selected fusion weights (w0, w1) equal to (0.75, 0.25). In other words, a smaller adaptive weight is used for a smaller selected reference line index. In some embodiments, the candidate multi-line fusion weight sets (w0, w1) may comprise (1, 0), (0.875, 0.125), (0.75, 0.25), (0.625, 0.375), (0.5, 0.5) or a combination of thereof. The said decision threshold values can be further signalled in the bitstream. For another example, a video coder may derive the selected set of the fusion weights for intra predicting a current block by comparing the template-matching costs associated with the fused signals derived by candidate fusion weight sets individually. In one embodiment, a video coder may determine to select the set of fusion weights leading to the lowest template matching cost for intra predicting a current block. In some embodiments, a video coder may further signal one or more syntax elements to indicate the values of multi-line fusion weights for intra predicting a current block. For example, a video coder may signal one or more syntax elements to specify the fusion weights in one or more high-level syntax sets such as SPS, PPS, PH, and SH. In some embodiments, a video coder may signal one or more syntax elements in a current block for deriving the selected multi-line fusion weights for intra predicting the current block.

In ECM-8.0, given a specified reference line index n, a fused intra prediction signal formed by multi-line fusion for predicting a current block always employs the reference lines n and n+1 for deriving the two intra predictors. According to another aspect of the present invention, a video coder may form a fused intra prediction signal by using different combinations of reference lines. In some embodiments for a specified reference line index n greater than 0, a video coder may generate an intra prediction signal for multi-line intra fusion utilizing two reference lines indexed by n and n−1, as follows:

$${P}_{fusion} = w 0 * {P}_{m , n} + w 1 * {P}_{m , n - 1} ,$$

wherein P_{m, n} and P_{m, n-1} correspond to the prediction signals derived by the reconstructed samples from the reference lines indexed by n and n−1, respectively, using the intra prediction mode m. The video coder may further comprise the constraint that w0 is greater than or equal to w1. In some embodiments for a specified reference line index n greater than 0, a video coder may generate an intra prediction signal for multi-line intra fusion utilizing two reference lines indexed by n and 0 under a constraint that the fusion weight for the reference line n is greater than or equal to the fusion weight for the reference line 0. In some embodiments, the proposed method may further comprise determining a combination of two reference lines used for multi-line intra fusion. A video coder may adaptively select two reference lines indexed by n0 and n1, respectively, for intra predicting a current block, as follows:

$${P}_{fusion} = w 0 * {P}_{m , n 0} + w 1 * {P}_{m , n 1} .$$

The proposed method may further comprise generating an intra prediction signal by multi-line intra fusion utilizing more than two reference lines. For example, a video coder may form a fused intra prediction signal by multi-line fusion utilizing three reference lines indexed by n0, n1 and n2, as follows:

$${P}_{fusion} = w 0 * {P}_{m , n 0} + w 1 * {P}_{m , n 1} + w 2 * {P}_{m , n 2}$$

where P_{m, n0}, P_{m, n1} and P_{m, n2} correspond to the prediction signals derived by the reconstructed samples from the reference lines indexed by n0, n1, and n2, respectively, using the intra prediction mode m, and w0, w1 and w2 are the fusion weights for predictors P_{m, n0}, P_{m, n1} and P_{m, n2}, respectively. In some embodiments, the selected reference line indices and the values of the fusion weights may be pre-defined and derived by some specified rules. In one specific embodiment, when the specified reference line index n is greater than 0, a video coder may generate a fused prediction signal for intra predicting a current block by a fusion of three intra predictors derived by the reconstructed samples from three adjacent reference lines indexed by n−1, n, and n+1, respectively, using a specified intra prediction mode m with fusion weight set (0.25, 0.5, 0.25), as follows:

$${P}_{fusion} = ( {P}_{m , n - 1} + 2 * {P}_{m , n} + {P}_{m , n + 1} + 2 ) ≫ 2$$

In some other embodiments, a video coder may signal one or more syntax elements to indicate the selected reference line indices and/or multiline fusion mode for intra predicting a current block. For example, a video coder may signal one or more syntax elements to specify the reference line indices for multi-line intra fusion in one or more high-level syntax sets such as SPS, PPS, PH, and SH. In some embodiments, a video coder may signal one or more syntax elements in a current block for deriving the selected reference line indices for intra predicting the current block.

The proposed method may further comprise signaling one or more syntax elements in one or more high-level syntax sets to indicate whether the proposed method is enabled or disable in a current video data unit, wherein the high-level syntax sets may comprise SPS, PPS, PH, SH, or a combination thereof. For example, a video coder may signal a syntax element sps_multiline_fusion_enable_flag to indicate whether multi-line fusion is enabled for deriving a intra prediction signal for predicting a current block.

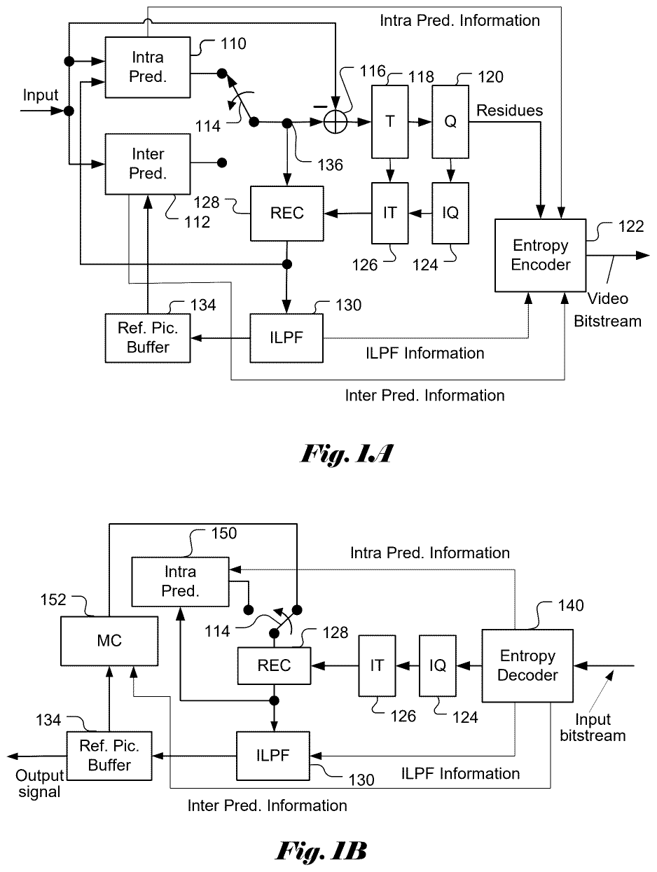

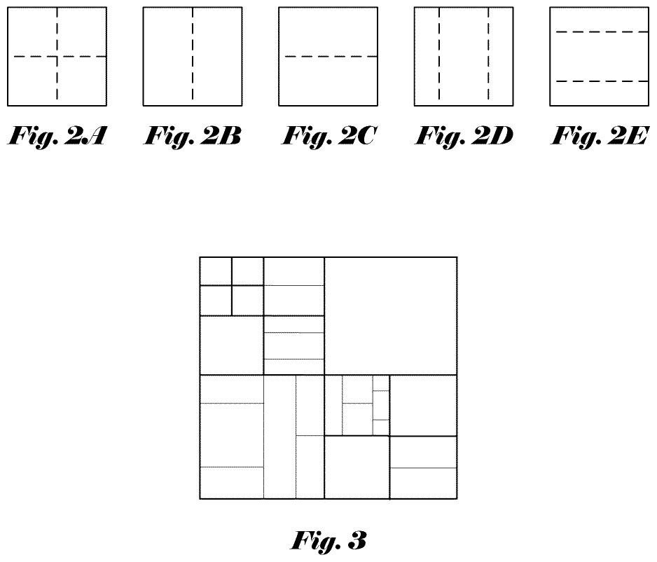

Any of the foregoing proposed fused predictor with adaptive weights methods can be implemented in encoders and/or decoders. For example, any of the proposed methods can be implemented in an intra prediction module of an encoder, and/or an intra prediction module of a decoder. Alternatively, any of the proposed methods can be implemented as circuit integrated to the intra prediction module of the encoder and/or the intra prediction module of the decoder. The proposed aspects, methods and related embodiments can be implemented individually or jointly in an image and video coding system. For example, the fused multi-line predictor as described above can be implemented in an encoder side or a decoder side with reference to FIG. 1A and FIG. 1B. For example, any of the proposed fused predictor with adaptive weights methods can be implemented in an Intra coding module (e.g. Intra Pred. 150 in FIG. 1B) in a decoder or an Intra coding module in an encoder (e.g. Intra Pred. 1102 in FIG. 1A). Any of the proposed fused predictor with adaptive weights methods can also be implemented as circuits coupled to the intra coding module at the decoder or the encoder. However, the decoder or encoder may also use additional processing unit to implement the required processing. While the Intra Pred. units (e.g. unit 110 in FIG. 1A and unit 150 in FIG. 1B) are shown as individual processing units, they may correspond to executable software or firmware codes stored on a media, such as hard disk or flash memory, for a CPU (Central Processing Unit) or programmable devices (e.g. DSP (Digital Signal Processor) or FPGA (Field Programmable Gate Array))

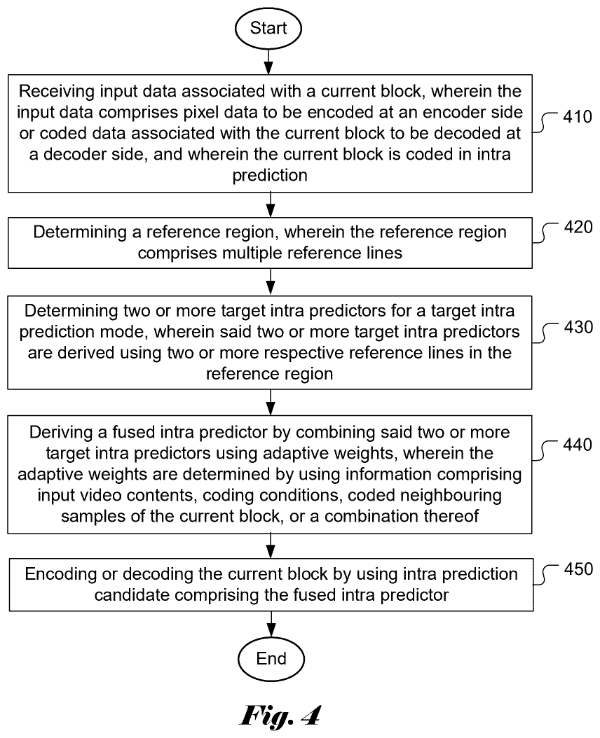

FIG. 4 illustrates a flowchart of an exemplary video coding system that incorporates a fused predictor with adaptive weights according to an embodiment of the present invention. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to this method, input data associated with a current block are received in step 410, wherein the input data comprises pixel data to be encoded at an encoder side or coded data associated with the current block to be decoded at a decoder side, and wherein the current block is coded in intra prediction. A reference region is determined in step 420, wherein the reference region comprises multiple reference lines. Two or more target intra predictors for a target intra prediction mode are determined in step 430, wherein said two or more target intra predictors are derived using two or more respective reference lines in the reference region. A fused intra predictor is derived by combining said two or more target intra predictors using adaptive weights in step 440, wherein the adaptive weights are determined by using information comprising input video contents, coding conditions, coded neighbouring samples of the current block, or a combination thereof. The current block is encoded or decoded by using intra prediction candidate comprising the fused intra predictor in step 450.

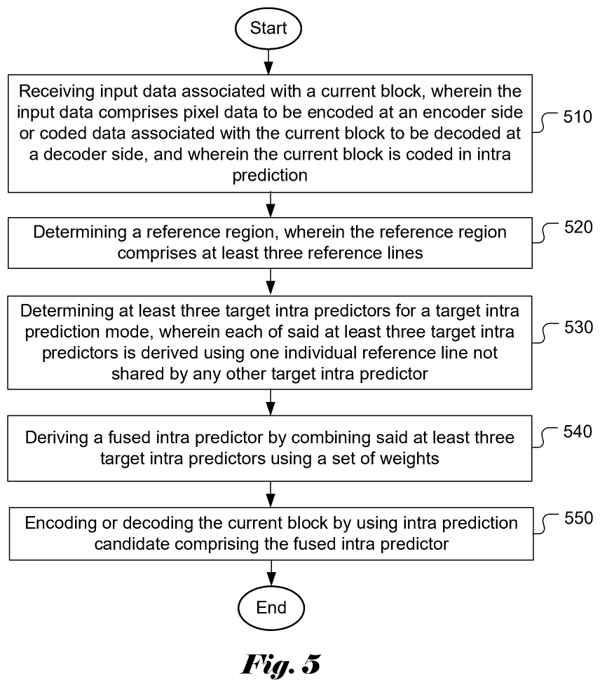

FIG. 5 illustrates a flowchart of another exemplary video coding system that incorporates a fused predictor by combining at least three intra predictors derived using individual reference lines according to an embodiment of the present invention. According to this method, input data associated with a current block are received in step 510, wherein the input data comprises pixel data to be encoded at an encoder side or coded data associated with the current block to be decoded at a decoder side, and wherein the current block is coded in intra prediction. A reference region is determined in step 520, wherein the reference region comprises at least three reference lines. At least three target intra predictors are determined for a target intra prediction mode in step 530, wherein each of said at least three target intra predictors is derived using one individual reference line not shared by any other target intra predictor. A fused intra predictor is derived by combining said at least three target intra predictors using a set of weights in step 540. The current block is encoded or decoded by using intra prediction candidate comprising the fused intra predictor in step 550.

The flowchart shown is intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video coding, the method comprising:
receiving input data associated with a current block, wherein the input data comprises pixel data to be encoded at an encoder side or coded data associated with the current block to be decoded at a decoder side, and wherein the current block is coded in intra prediction;
determining a reference region, wherein the reference region comprises multiple reference lines;
determining two or more target intra predictors for a target intra prediction mode, wherein said two or more target intra predictors are derived using two or more respective reference lines in the reference region;
deriving a fused intra predictor by combining said two or more target intra predictors using adaptive weights, wherein the adaptive weights are determined by using information comprising input video contents, coding conditions, coded neighbouring samples of the current block, or a combination thereof; and
encoding or decoding the current block by using intra prediction candidate comprising the fused intra predictor.

2. The method of claim 1, wherein the adaptive weights are derived based on template-matching costs calculated on one or more templates based on reconstructed samples and predicted samples of said one or more templates, wherein the predicted samples are derived according to said two or more target intra predictors.

3. The method of claim 2, wherein said two or more target intra predictors correspond to a first target intra predictor and a second target intra predictor associated with a first reference line and a second reference line respectively and the template-matching costs correspond to a first template-matching cost and a second template-matching cost, the adaptive weights associated with the first target intra predictor and the second target intra predictor are proportional to the second template-matching cost and the first template-matching cost respectively.

4. The method of claim 1, wherein the adaptive weights are determined from pre-defined weight sets.

5. The method of claim 4, wherein the pre-defined weight sets comprise (1, 0), (0.875, 0.125), (0.75, 0.25), (0.625, 0.375), (0.5, 0.5), or a combination thereof.

6. The method of claim 4, wherein the adaptive weights are derived from pre-defined weight sets implicitly based on block dimension, quantization parameter (QP), selected reference line index n, prediction mode associated with the current block, or a combination thereof.

7. The method of claim 1, wherein the adaptive weights are selected according to a selected reference line index associated with a selected target intra predictor.

8. The method of claim 7, wherein if the selected reference line index is greater than a positive threshold, a corresponding adaptive weight is set to 0.5; otherwise if the selected reference line index is greater than 0, the corresponding adaptive weight is set to 0.75; and otherwise, the corresponding adaptive weight is set to 1.

9. The method of claim 7, wherein a smaller adaptive weight is used for a smaller selected reference line index.

10. The method of claim 1, wherein said two or more target intra predictors correspond to three target intra predictors and the adaptive weights comprise (0.25, 0.5, 0.25).

11. The method of claim 1, wherein one or more syntax elements are used to indicate values of the adaptive weights.

12. The method of claim 11, wherein said one or more syntax elements are signalled in SPS (Sequence Parameter Set), PPS (Picture Parameter Set), PH (Picture Header), SH (Slice Header), or a combination thereof.

13. The method of claim 1, wherein one or more high-level syntax sets are used to indicate whether the adaptive weights are used to form the fused intra predictor.

14. The method of claim 13, wherein said one or more high-level syntax sets are signalled in SPS (Sequence Parameter Set), PPS (Picture Parameter Set), PH (Picture Header), SH (Slice Header), or a combination thereof.

15. An apparatus of video coding, the apparatus comprising one or more electronics or processors arranged to:
receive input data associated with a current block, wherein the input data comprises pixel data to be encoded at an encoder side or coded data associated with the current block to be decoded at a decoder side, and wherein the current block is coded in intra prediction;
determine a reference region, wherein the reference region comprises multiple reference lines;
determine two or more target intra predictors for a target intra prediction mode, wherein said two or more target intra predictors are derived using two or more respective reference lines in the reference region;
derive a fused intra predictor by combining said two or more target intra predictors by using adaptive weights, wherein the adaptive weights are determined using information comprising input video contents, coding conditions, coded neighbouring samples of the current block, or a combination thereof, and
encode or decode the current block by using intra prediction candidate comprising the fused intra predictor.

16. A method of video coding, the method comprising:
receiving input data associated with a current block, wherein the input data comprises pixel data to be encoded at an encoder side or coded data associated with the current block to be decoded at a decoder side, and wherein the current block is coded in intra prediction;
determining a reference region, wherein the reference region comprises at least three reference lines;
determining at least three target intra predictors for a target intra prediction mode, wherein each of said at least three target intra predictors is derived using one individual reference line not shared by any other target intra predictor;
deriving a fused intra predictor by combining said at least three target intra predictors using a set of weights; and
encoding or decoding the current block by using intra prediction candidate comprising the fused intra predictor.

17. The method of claim 16, wherein said at least three target intra predictors correspond to a first target intra predictor, a second target intra predictor and a third target intra predictor derived based on reference line indexes (n−1), n, and (n+1) respectively, and wherein n is an integer greater than 0.

18. The method of claim 17, wherein the set of weights corresponds to (0.25, 0.5. 0.25).

19. An apparatus of video coding, the apparatus comprising one or more electronics or processors arranged to:
receive input data associated with a current block, wherein the input data comprises pixel data to be encoded at an encoder side or coded data associated with the current block to be decoded at a decoder side, and wherein the current block is coded in intra prediction;
determine a reference region, wherein the reference region comprises at least reference lines;
determine at least three target intra predictors for a target intra prediction mode, wherein each of said at least three target intra predictors is derived using one individual reference line not shared by any other target intra predictor;
derive a fused intra predictor by combining said at least three target intra predictors using a set of weights; and
encode or decode the current block by using intra prediction candidate comprising the fused intra predictor.
